(19) United States
(12) Patent Application Publication
(10) Pub. No.: US 2014/0289344 A1
(43) Pub. Date: Sep. 25, 2014

(54) DIGITAL NOTIFICATION ENHANCEMENT SYSTEM

(71) Applicants: Jeff CALHOUN, Lansing, MI (US); John MCGEARY, Blaine, MN (US); Robert STUMP, Shepherd, MI (US)

(72) Inventors: Jeff CALHOUN, Lansing, MI (US); John MCGEARY, Blaine, MN (US); Robert STUMP, Shepherd, MI (US)

(21) Appl. No.: 14/198,910

(22) Filed: Mar. 6, 2014

Related U.S. Application Data
(60) Provisional application No. 61/774,168, filed on Mar. 7, 2013.

(51) Int. Cl. H04L 12/58; G06T 13/00

(52) U.S. Cl. CPC H04L 51/04; G06T 13/00
USPC 709/206

(57) ABSTRACT

This invention relates to an apparatus and method for a digital notification enhancement system. In particular, the invention relates to a method and apparatus for enhancing a header field, such as the subject field, of a notification such as an email to provide for animations and the like to placed in the field.

### RELATED APPLICATIONS

The present application claims priority to and incorporates by reference thereto, U.S. Provisional Patent Application No. 61/774,168 filed on Mar. 7, 2013.

### BACKGROUND

1. Field of the Invention

This invention relates to an apparatus and method for a digital notification enhancement system. In particular, the invention relates to a method and apparatus for enhancing a header field, such as the subject field, of a notification such as an email to provide for animations and the like to placed in the field.

2. Background of the Invention

Emails and other notices are now ubiquitous. It is not uncommon for people, especially in the business context, to receive hundreds of emails a day that have varying degrees of importance. Users have a difficult time sorting, prioritizing, and responding to all the notices they receive in part because all the notices look the same. The average email inbox is filled with emails with plan text subject lines making it hard to determine at a glance what is important and what is not.

The foregoing is also a problem for bulk emailers, who send out millions of emails advertising goods and services, promotions, events, and the like. These emails compete against all the other emails users receive for attention, and frequently are deleted without a second glance, because nothing distinguishes them from the rest of the emails in an inbox.

Therefore, a need exists for an improved method and apparatus for a digital notification enhancement system.

### BRIEF DESCRIPTION OF THE DRAWINGS

FIG. 1 shows a block diagram of a W3C framework.

FIG. 2 shows a flow diagram of server/client program environment.

FIG. 3 shows a block diagram showing the present invention in the context of several different OSs.

FIG. 4 is a block diagram of an implementation of the present invention.

FIG. 5 is a block diagram of another implementation of the present invention.

FIG. 6 is a block diagram of another implementation of the present invention.

FIG. 7 is a block diagram of another implementation of the present invention.

FIG. 8 is a block diagram of another implementation of the present invention.

FIGS. 9a through 9d show a workflow of the present invention.

### SUMMARY OF THE INVENTION

The present invention comprises a digital notification enhancement system. The invention translates the code/language and/or rules used to define and/or create specific action, format, and/or color across mediums in order display the information in a new and innovative way. The display options include but are not limited to enabling video and/or the animation of content to scroll, blink, shake, flash, wave or to be posted in color or with a colored background and/or sorted and any combination therein.

Notifications include but are not limited to emails, texts, and tweets. Notifications can occur on, across and/or between any digital communication devices. Devices include but are not limited to computers, tablets, mobile phones, video game consoles, and televisions. The invention allows users to easily recognize and identify certain communications as unique.

### DETAILED DESCRIPTION OF THE PREFERRED EMBODIMENTS

An example of an alert or notification of the present invention includes but is not limited to displaying an animated subject line in an email in response to a user specified event. In the prior art, email inboxes are full of countless emails many of which at a minimum go unopened, or deleted without opening, and often go completely unnoticed because nothing distinguishes them from each other which brands them as junk/unimportant messages.

With the present invention, a user can create/choose a subject line for an email messages having a wide variety of effects and attributes beside plain text, which include a specific sender scroll, blink, shake, flash, wave, and/or the subject line can be posted with a colored background or content and/or any combination therein. The ways in which the subject line of the email can be displayed beyond being static, motionless, and black and white are limited only by the imagination of the user. Of course, the invention is not limited to emails, but can also include other messaging and notification systems and technologies including, texts messages, instant messaging, tweets, social media posts, and the like.

In this example of the present invention, the email is received in the same manner they have been historically, with the exception that the content contained in the subject line can, for example, scroll like a ticker rather than sit motionless.

A user can also choose to apply the present invention to highlight and enhance any or all sections of the email header including but not limited to the sender, recipient, subject, sending time stamp, receiving time stamps of all intermediate and the final mail transfer agents that identify an individual email.

### Additional Configurations of the Present Invention

Additional configurations of the present invention include but are not limited to enabling content, contained in notifications/messages/updates displayed on televisions or through other devices through social network sites including but not limited to Facebook, Twitter and Linkedln, to scroll, blink, shake, flash, wave or to be posted in color or with a colored background and/or any combination therein.

The invention can be set up as a standalone, user defined communication application. It can be configured to interact between consumers, consumers and business and from business to business through existing websites and/or in conj unction with Internet service providers (ISPs) and existing communication technologies.

The invention can also be incorporated into any third party website. It can be configured to interact between corporate websites and consumer websites and/or in conjunction with Internet service providers (ISPs) and existing communication devices.

In this format, the user would select or opt-in through the individual websites. The consumer is choosing to engage the tool, requesting communications across user defined/specified channels including but not limited to emails, texts, and tweets.

The present invention is not limited to user defined events. It can be used in the form of push communications, for example used by business. Applications can include but are not limited to integration with digital media campaigns, customer management practices, and consumer protection services.

In this format, the business would select when to leverage the tool proactively. The business integrates the tool into their processes and communications, increasing the likelihood of achieving the desired result.

The present invention is flexible. The end user can configure the system to disable the animation or other effects once the consumer has clicked on or opened the specific communication. The user can choose the level of importance of the action. The technology can be configured so that one notification receives one type of action, while other events trigger different actions (i.e. scroll vs. blink). The user can define a graduation effect. This capability allows for increased levels of animation based on additional events taking. The speed of the animation can be selected (i.e. how often content blinks and or how fast content scrolls).

The present invention can create logs and histories of actions and allows for communication types including but not limited to Email, Text, and Twitter to be sorted, prioritized and/or highlighted further using predetermined criteria.

The invention at its most basic level allows for basic animation like scrolling and/or blinking content within the subject line of an email but can go so far as to allow animated objects, like emoticons as an example, all the way to allowing for full video to be displayed.

### Additional Examples of the Present Invention

Within each configuration, there are many ways the present invention can be applied to improve digital communications for both consumers and business. Neither the number of configurations nor the examples provided are meant to be limiting in terms of the scope of the invention but are instead exemplary. They are meant to illustrate the vast number of situations and uses for the technology and each may have applications across and among each other.

Standalone Uses
Consumer protection
Reminder tool tied to calendars, schedules

Third Party Websites Uses
Texts alerts (invoice due date, purchase confirmation, account management verification)
Retail alerts
Mobile text messaging
Social network alerts

Push Communications
Marketing solicitations
Consumer verification

### Technology Overview of the Present Invention

The basic anatomy of an email message comprises the following three parts: 1) the message envelope; 2) the message header; and 3) the message body. One example of the present invention focuses upon the email's “SUBJECT LINE” within the header but is applicable to the other elements and subjects as described herein.

The header—a set of lines containing information about the message's transportation, such as the sender's address, the recipient's address, or timestamps showing when the message was sent by intermediary servers to the transport agents (MTAs). The header begins with a “From” line and is changed each time it passes through an intermediary server. Using headers, you can see the exact path taken by the email, and how long it took each server to process.

The message is made up of the following elements:
1. Header fields: a set of lines describing the message's settings, such as the sender, the recipient, the date, etc. Each one has the following form:
   An email includes at least the four following headers:
   Name: Value
   From: The sender's email address
   To: The recipient's email address
   Date: The date when the email was sent
      Optional fields:
   Received: Various information about the intermediary servers and the date when the message was processed.
   Reply-To: A reply address.
   Subject: The message's subject
   Message-ID: A unique identification for the message.
2. Message body: the email message that is separated from the header by a line break.
3. Envelope: The envelope, also known as the journal messages that are sent to the journaling mailboxes are MAPI messages (the body of which is the original message sent by the sender). These MAPI messages contain the journaling property, which also contains all the recipient information for the message. The journaling mailbox requests that the Exchange Store service package an envelope message that contains all this data. The resulting message is similar to a non-delivery report (NDR) message. The body contains Exchange-generated data (in this case the sender, the original message ID, and a list of recipients), and the original message is attached. Until the journal message is created by the Exchange server that hosts the journal recipient mailbox, envelope data is attached as a property to the message instead of copied as embedded content. Attaching the envelope data as a property is done so that existing mailbox servers do not have to manage the additional transaction volume that the Exchange Store service creates when constructing journal reports locally at the point of data gathering. Instead, the mailbox servers that host the journal mailboxes assume the responsibility for constructing journal reports at delivery time.

An email is made up of lines of displayable 7-bit US-ASCII characters. Each line has at most 76 characters, for compatibility reasons, and ends with the characters CRLF (\r\n).

### Server-side Application or Webserver Delivery

The application to animate the “Subject line” of the email message in accordance with the present invention can run either on a server-side application, such as a web server (Apache, IIS, or any other past, present, or future web server infrastructures). The invention can modify the “Subject line” content in appearance, image sets (e.g.—logos), or content to be displayed in a modified behavior. The coding to manipulate the “Subject line” for a server-side based email system can be achieved through a multitude of programming languages from, but not limited to, Perl, CGI, ASP, .NET programming, Java, PHP, html, DHTML, Javascript, or any other past, present, or future programming languages related to web development applications.

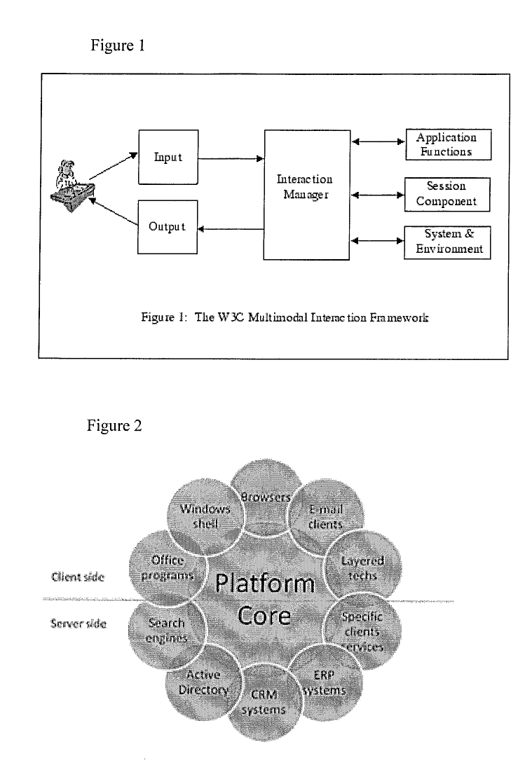

The following discussion uses the W3C Framework model as defined for most web based applications, as shown in FIG. 1, with additional detail to follow. As shown in FIG. 1, the model includes a human user who enters input into the system and observes and hears output presented by the system. Input comprises an interactive multimodal implementation that can use multiple input modes such as audio, speech, handwriting, and keyboarding, and other input modes. Output comprises an interactive multimodal implementation that can one or more modes of output, such as speech, text, graphics, audio files, and animation. The interaction manager comprises a logical component that coordinates data and manages execution flow from various input and output modality component interface objects. The interaction manager maintains the interaction state and context of the application and responds to inputs from component interface objects and changes in the system and environment. The interaction manager then manages these changes and coordinates input and output across component interface objects. In some architectures, the interaction manager may be implemented as one single component. In other architectures, the interaction manager may be treated as a composition of lesser components. Composition may be distributed across process and device boundaries. The session component provides an interface to the interaction manager to support state management, and temporary and persistent sessions for multimodal applications. This will be useful in the following scenarios but is not limited to these: a user is interacting with an application which runs on multiple devices; the application is session based e.g. multiplayer game, multimodal chat, meeting room etc; the application provides multiple modes of providing input and receiving output; and the application runs on a single device and needs to experience multimodality by switching modes. The system and environment component enables the interaction manager to find out about and respond to changes in device capabilities, user preferences, and environmental conditions.

### Client-side Applications/Email Applications/Client—Server Applications

The application to modify the “Subject line” of the email message on a client operating system of Windows, Linux, or any other past, present, or future operating systems could be delivered to the client via a web download, application installer (e.g.—MSI, InstallShield, etc.), zip package, or other application delivery methods for an end-user to install software. The same principle will be inferred for phone and mobile technologies such as Android or Apple iOS, but not limited to those infrastructures and could be adapted for any present or future technologies as technology advances are made in the mobile applications development lifecycle.

FIG. 2 shows a general state diagram of client and server side applications and interactions therebetween, wherein a user can utilize various application seamlessly via client sided applications (including an email client) either is a standalone manner of in combination with server/internet based applications. The present invention is adapted to operate in such an environment.

A client-based application, if installed, could be adapted to modify the “Subject line” of the email message through the applications interface with the email program to provide the enhancement of the “Subject line” to deliver content in appearance, image sets (e.g.—logos), or content to be displayed in a modified behavior; some examples that could make this modification include, but not limited to, modifications via an add-in for Microsoft Products, Java, PowerShell, Eudora, Linux email clients, custom email programs, or any other additional client email applications past, present, or future that through the use of an integrated API (Application Programming Interface) or other tool to display the “Subject line” in the manners described herein and still retain the integrity of the email, operating system, and client security.

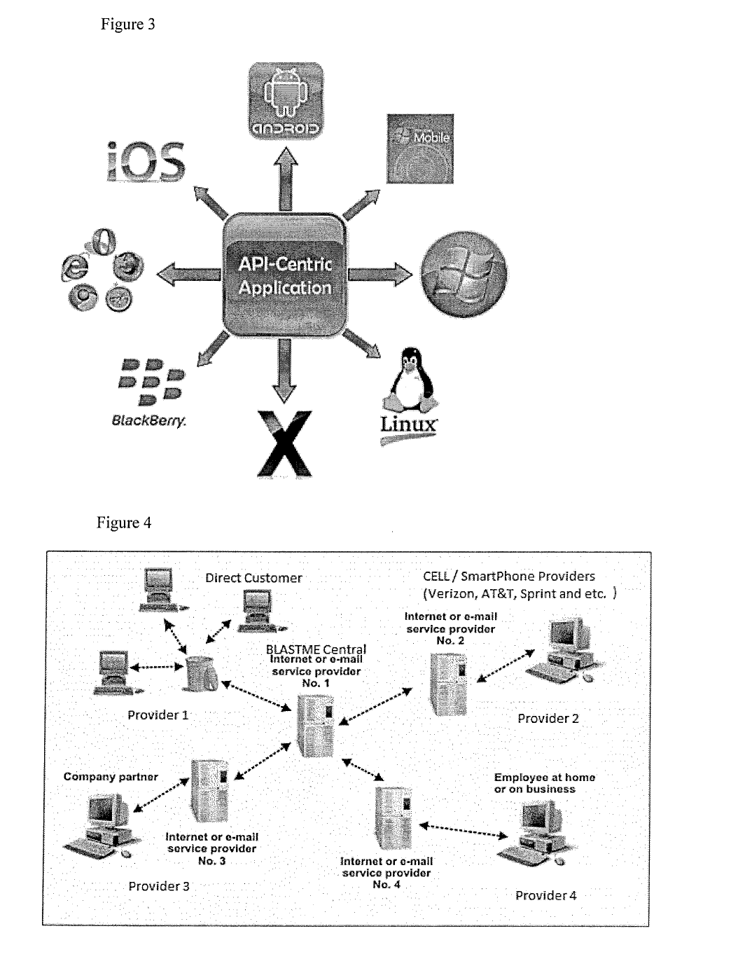

FIG. 3 shows how the present invention can be adapted through an API, or similar functionality, to operate in a wider variety of operating environments.

### Source Code and Compiler of the Present Invention

The diagrams depicted in FIGS. 4-8 outline the interconnections between the partners, general (basic) outline model and where the API should integrate within a sample program (e.g.—MS Outlook). These are common knowledge pieces but they substantiate the fundamental idea behind the invention.

### Customer and Partner Connections (High Level Operational Flow)

FIG. 4 shows a variety of configurations of a centralized server housing the present invention (entitled BLASTME), and how it can connect with various user systems, including direct connections, through a mobile provider and OS, through a company network, or to an employee at work or working remotely from home.

### Customer Tools to Interface with Present Invention, Web—Server Online

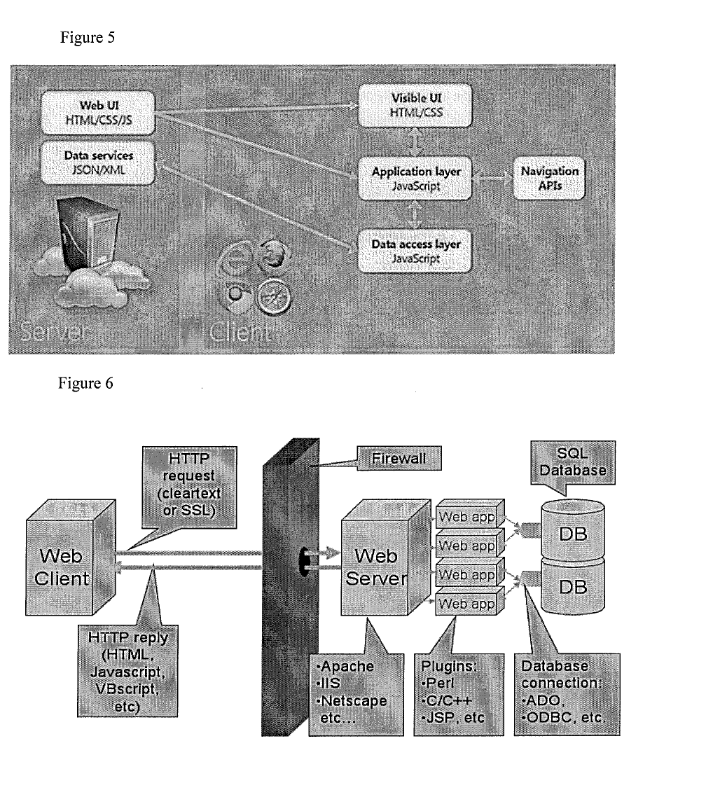

FIG. 5 shows client/server configuration adapted for online or internet use via a web based platform through a scripting language such as JavaScript.

FIG. 6 shows in more detail the workflow of a web based application environment, which is suitable for application of the present invention.

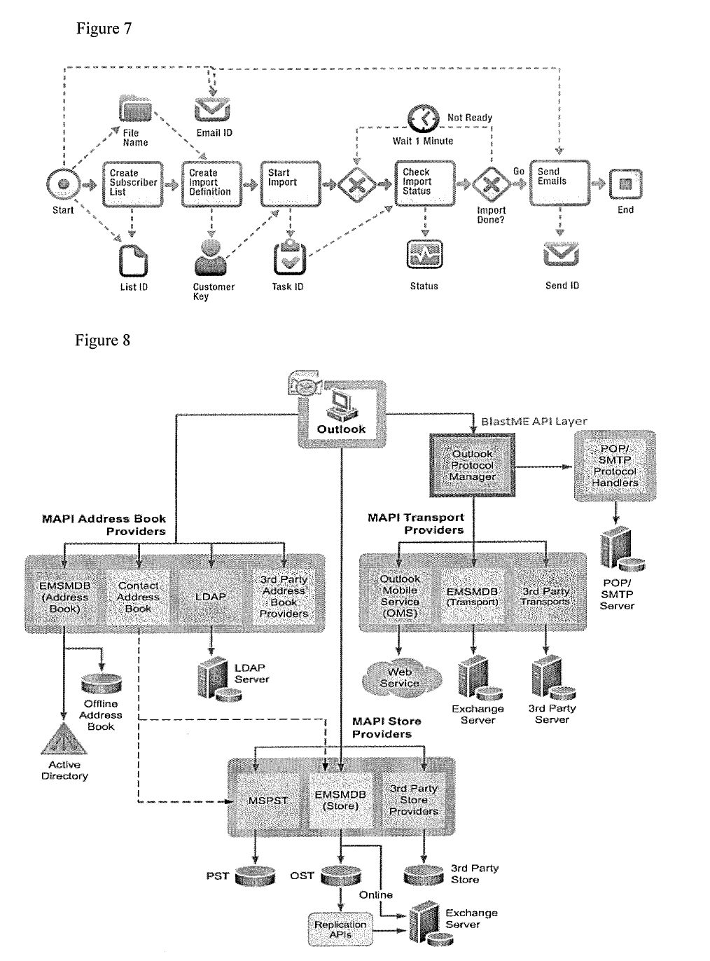

FIG. 7 shows a process workflow for a subscriber based implementation of the present invention; process request and confirm/validate before sending to end user:

FIG. 8 shows an optimal usage API; Microsoft Outlook interface connection (Program layer and Interfaces) for implementing the present invention.

The following illustrates a mock software build (aka pseudo code) and delivery of one application of the present invention to achieve the desired results for the end users (aka subscribers).

Before any program can be executed, it must first be built. This initial code is referred to as “Source Code” and using this as the base foundation is important to the entire framework of the application. Source code (also referred to as source or code) is the version of software as it is originally written (i.e., typed into a computer) by a human in plain text (i.e., human readable alphanumeric characters).

The term software refers to all operating systems, application programs, and data that are used by products containing microprocessors (also called processors or central processing units). Such products include not only personal computers but also a vast array of other products, such as tablets, smartphones, and any other device that can run a program.

Source code can be written in any of the hundreds of programming languages that have been developed. Some of the most popular of these are C, C++, COBOL, FORTRAN, Java, Perl, PHP, Python, Visual Basic, ASP .NET, and many other variations of developer based programming tools.

There are many programs that can be used for writing source code in the desired programming language, ranging from simple, general purpose text editors (such as vi or gedit on Linux or Notepad on Microsoft Windows) to integrated development environments (such as Visual C++ on Microsoft Windows or the cross-platform Eclipse Platform for constructing and running integrated software-development tools on smartphones for Android or Apple IOS). After writing this source code, the source code is saved in a single file or, more commonly, in multiple files, with the number of files depending on such factors as the programming language and the size of the project.

Most software development programs include a compiler, which translates source code files into machine code or object code. Since this code can be executed directly by the computer's processor, the resulting application is often referred to as an executable file. Windows executable files have an .EXE file extension, while Mac OS X programs have an .APP extension, which is often hidden. Upon a completed source code package that has been tested and ready for production, the delivery to end users must be compiled in the appropriate targeted package format depending upon the OS or device being built for, an act of compiling code is the portion of the build that creates the necessary installation file that can be installed on a client PC, tablet, smartphone, or other device that is capable of running an application.

The sample source code that is being used for the example given in this document is written in source code and not compiled; as compiled code is illegible for reading by human interaction or legibility. The example below illustrates the source code, one of many to do basic routines that would modify, validate a subscriber, and give an end result.

### Example Code of the Present Invention Using VisualBasic Pseudo Code

### Server Delivery (If Webserver Example)

Example using PHP & Perl from a script running on an email server. In this example running strictly from a webserver to manage and validate the execution delivery of a subscriber message through the shell exec controls parameters and specific arguments presented by the end user on how they want to receive their email notifications. If the subscriber is not a valid subscriber the application will terminate with a notification message indicating the subscriber is not a member of the system.

```
    <?php
    $from = $_POST[‘from’];
    $to = $_POST[‘to’];
    $plain_text = $_POST[‘html’];
    header(“Content-type: image/message”);
      if ($to == ‘whatever_allowed@example.com’){
      header(“HTTP/1.0 200 OK”);
      echo(‘success’);
      shell_exec(“perl modifysubjectapp.pl arg1 arg2 arg3”);
      }else{
      header(“HTTP/1.0 403 OK”);
      echo(‘User not subscribed to receive this type of message’);
      }
      exit;
    ?>
    modifysubjectapp = /path/to/modifysubjectapp
    cat | $modifysubjectapp -R Subject: X-Subject: -A “Subject:
    <SERVERIMG> $color
= <BLUE> SUBJECT CONTENT” > in.$$
```

### Psuedo Code Workflow

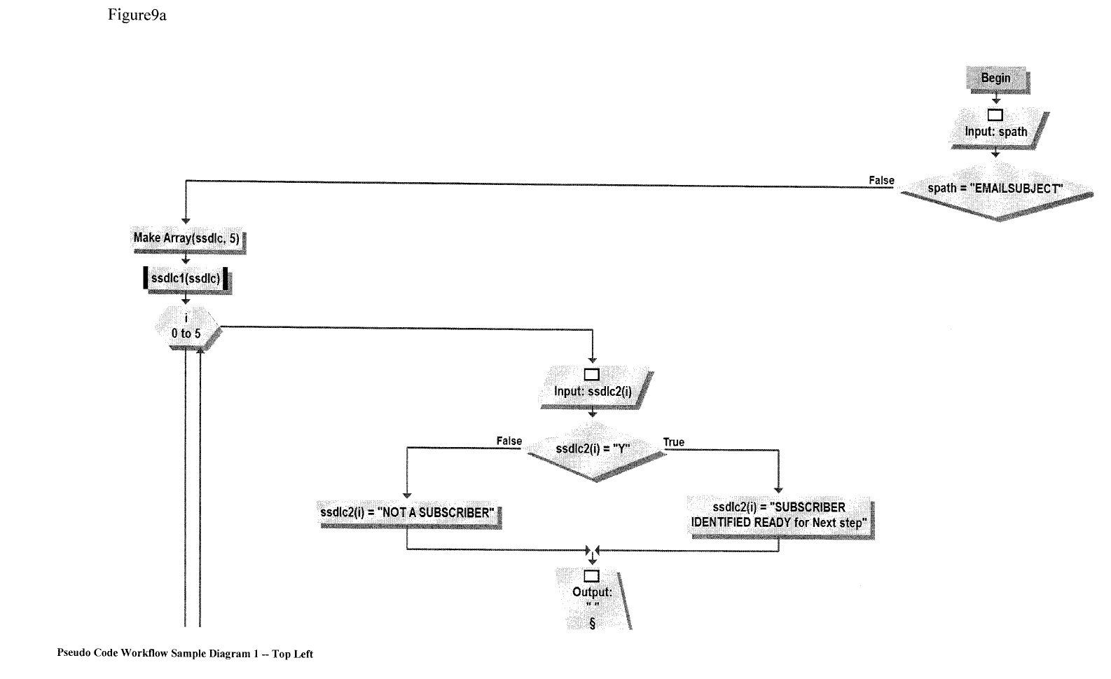

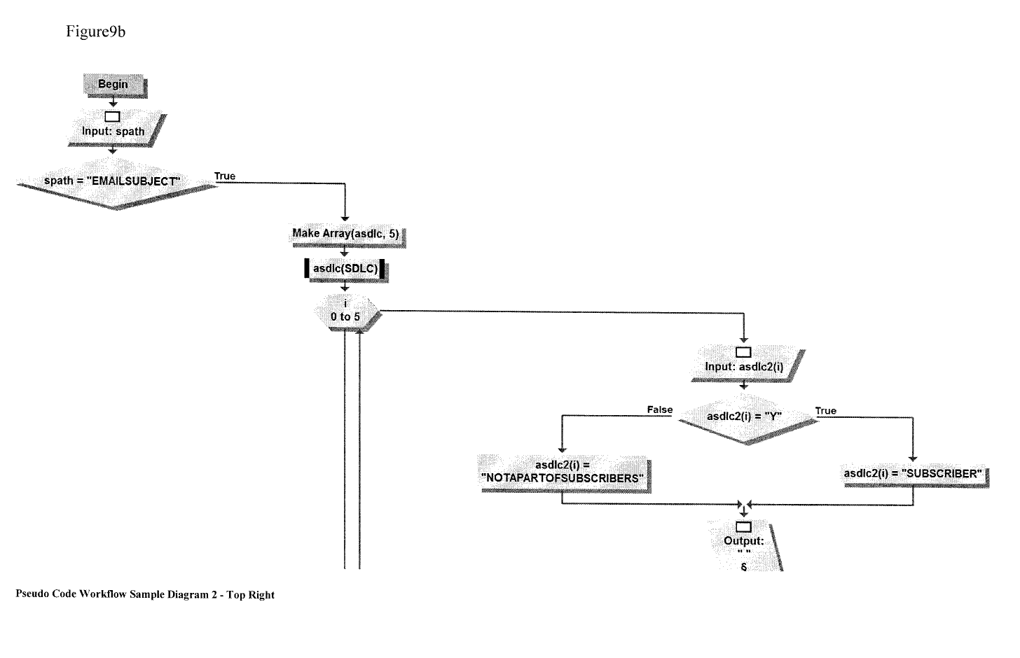

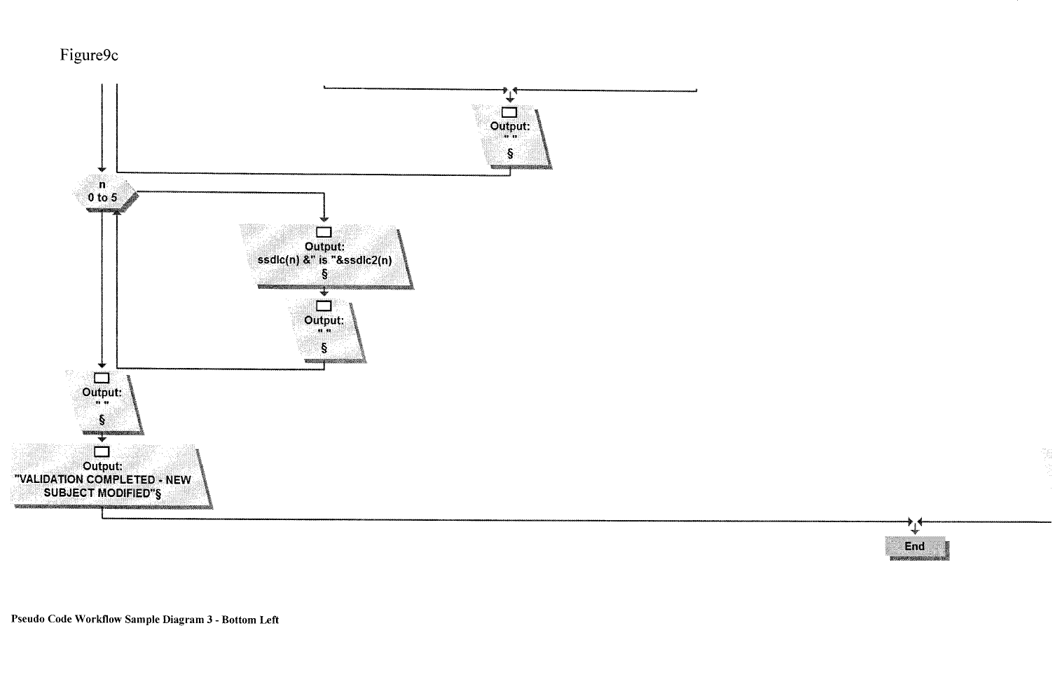

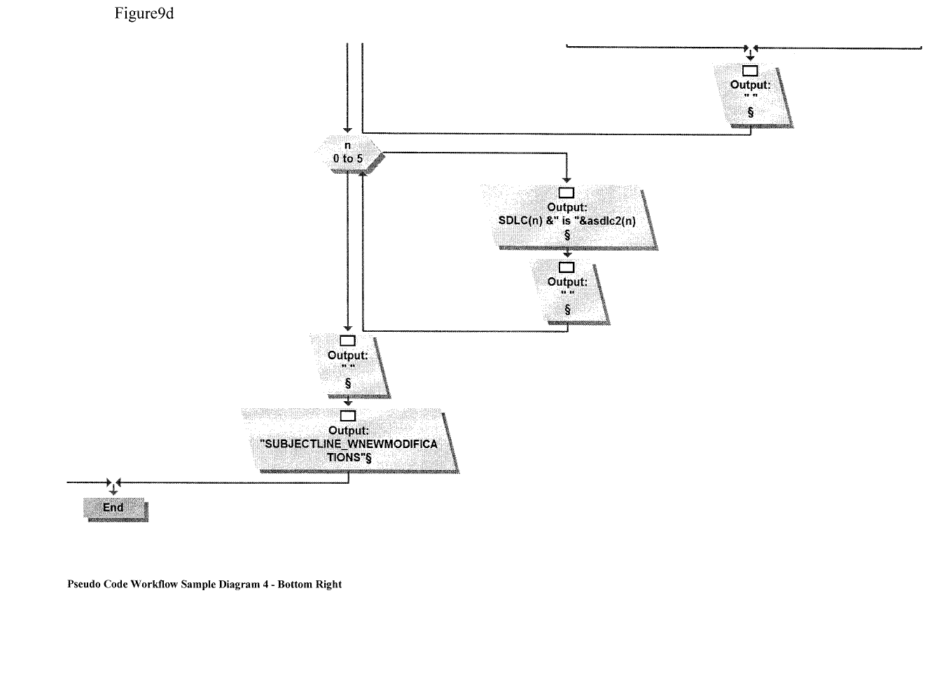

FIGS. 9a and 9b show a workflow for implementing the present invention, for clarity the flow has been broken onto two pages. The first page being the “False” (left) side of the flow and the second page being the “True” (right) side of the flow.

### Psuedo Code Workflow Continued

### Delivery and Installation of the Present Invention

After the source code has been debugged, tested, and validated to be free of errors the next step would be the package and delivery of the code then known as an executable application that can be delivered or put into production usage for any client to utilize and access. An application is the compilation computer instructions or a collection of instructions for a particular function, is a defined as a program. A collection of programs to carry out a specific task is referred to as a package or application package. The term software applies to applications programs, specialized system programs, or operating system utilities (which relates to operating the computer system). There are many variations to deliver the application to allow the end user or client to access this “Subject line” application. The example will follow the delivery to a client PC, but not limited to only delivering to a client; this could be used to deliver to a webserver for a web-based email platform if deemed.

Once the compiled code is packaged and ready for delivery, the end user can download this package to install on their local PC or as an available add-in for Microsoft Outlook. This example will use as a downloaded installation package delivery via a website.

The user will install this application through a website download, http://whatever.example.com to install this application. Once the end-user has downloaded the application, the process of installation will follow a series of basic questions around subscriber ID (for example, to validate their ownership and or license key), their email address (to process the “Subject line” parameters), and to agree to any licensing terms and agreements necessary to be compliant and acknowledge that their actions authorize the use of this application to make the needed changes within their email client or modify their systems to allow the application to operate properly as intended.

Upon completion and delivery of the software application, the email client used and through the action of being a validated “subscriber” to whatever system will modify the subject line to include images, scrolling text, color coded modifications, or any other identifier that could be leveraged to make the “Subject line” of the message more prominent to the end user as an end result. This overlay, integration, or interaction with the email client will promote the “Subject line” delivery process all at the request of the end user of the application without any further actions by the end user to highlight, identify, or illustrate the subscription, information, or other request to make known of the “Subject line” through the promotion of visual identification, banners, images, marquee, or color highlighting the “Subject line” while utilizing this application.

The above pseudo code and illustrations are intended for people skilled in the field and are meant for those individuals to readily understand the scope of Blast Me. The descriptions, illustrations, and explanations of the technology above have been limited to a single configuration only because of the almost limitless possibilities of the technology and are not to be considered limiting in terms of Blast Me scope.

In addition, Blast Me applies to any like hardware configuration. The technology translates whether the computer systems are complicated, multi-user computing equipment, single user workstations, hand-held devices, televisions, or network appliances that may not have their own storage. It is also understood that while certain languages are referenced, Blast Me is capable of numerous other adaptations and configurations.

These and other advantages will be apparent to those of ordinary skill in the art.

While the preferred embodiment of the invention has been described in reference to the Figures, the invention is not so limited. Also, the method and apparatus of the present invention is not necessarily limited to digital signage, but can be applied to any field where real-time content verification is desired.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1. An method of animating an electronic message, wherein the steps of the method are carried out by one or more computers under the control of computer code, comprising:
providing an application for delivering a message, wherein the message is comprised of a header and a body;
modifying one or more fields of the header of the message to enhance the appearance of the field.

2. The method of claim 1 wherein the modifying step is performed by an add on to the provided application.

3. The method of claim 1 wherein the modifying step is performed by the provided application.

4. The method of claim 1 wherein the enhancement comprises an animation.

5. The method of claim 1 wherein the enhancement comprises a graphic animation.

6. The method of claim 1 wherein the enhancement comprises video.

7. The method of claim 1 wherein the enhancement comprises scrolling animation.

8. The method of claim 1 wherein the enhancement comprises a blinking animation.

9. The method of claim 1 wherein the enhancement comprises a flashing animation.

10. The method of claim 1 wherein the enhancement comprises a waving animation.

11. The method of claim 1 wherein the enhancement comprises a shaking animation.

12. The method of claim 1 wherein the field modified is the subject field.

13. The method of claim 1 wherein the message is an email.

14. The method of claim 1 wherein the message is a text message.

15. The method of claim 1 wherein the message is a social media posting.
